(19) United States
(12) Patent Application Publication
(10) Pub. No.: US 2026/0058170 A1
(43) Pub. Date: Feb. 26, 2026

(54) FUEL CELL STACK

(71) Applicant: TOYOTA JIDOSHA KABUSHIKI KAISHA, Toyota-shi (JP)

(72) Inventor: Rannosuke MAEDA, Susono-si (JP)

(73) Assignee: TOYOTA JIDOSHA KABUSHIKI KAISHA, Toyota-shi (JP)

(21) Appl. No.: 19/089,229

(22) Filed: Mar. 25, 2025

(30) Foreign Application Priority Data
Aug. 26, 2024 (JP) 2024-144173

(51) Int. Cl. H01M 8/0276; H01M 8/10

(52) U.S. Cl. CPC H01M 8/0276; H01M 2008/1095

(57) ABSTRACT

A fuel cell stack includes a plurality of fuel cells and an inter-cell sealing material disposed between the fuel cells. The fuel cells include a rib protruding in a direction of adjacent fuel cells. The rib is located outside the sealing range of the inter-sealing material. The rib has such a height that the compressibility of the inter-cell sealing material is 20% or more and 70% or less in the sealing range.

### CROSS-REFERENCE TO RELATED APPLICATION

This application claims priority to Japanese Patent Application No. 2024-144173 filed on Aug. 26, 2024. The disclosure of the above-identified application, including the specification, drawings, and claims, is incorporated by reference herein in its entirety.

### BACKGROUND

### 1. Technical Field

The present disclosure relates to a fuel cell stack that is a collection of a plurality of fuel cells stacked together.

### 2. Description of Related Art

Japanese Unexamined Patent Application Publication No. 2023-162470 (JP 2023-162470 A) discloses a structure of a fuel cell stack. In this structure, fuel cells are stacked together with a pressure-sensitive adhesive sheet disposed therebetween.

### SUMMARY

In a structure of a fuel cell stack in which a pressure-sensitive adhesive sheet is used as a seal between fuel cells, the pressure-sensitive adhesive sheet is compressed by a fastening load. Therefore, the adhesive sheet undergoes permanent deformation (compression set) in the thickness direction over time. As a result, the adhesive sheet may not be sufficiently conformable during unfastening or in case of fuel cell displacement, which may result in damage to the seal due to separation of the pressure-sensitive adhesive.

In view of the above issue, an object of the present disclosure is to provide a fuel cell stack that can reduce a maximum amount of permanent deformation of an inter-cell sealing material between fuel cells.

The present application discloses a fuel cell stack including:
a plurality of fuel cells; and
an inter-cell sealing material disposed between the fuel cells.
The fuel cells include a rib located outside a sealing range of the inter-cell sealing material.
The rib protrudes in a direction of adjacent ones of the fuel cells.
The rib has such a height that compressibility of the inter-cell sealing material is 20% or more and 70% or less in the sealing range.

The rib may be provided in a separator of the fuel cell.

The sealing range may be defined by a protruding portion provided in the separator.

The present application discloses a fuel cell stack including:
a plurality of fuel cells; and
an inter-cell sealing material disposed between the fuel cells.

The fuel cells include two or more ribs located inside a sealing range of the inter-cell sealing material.

The rib may have such a height that compressibility of the inter-cell sealing material is 20% or more and 70% or less in the sealing range other than the rib.

The rib may have such a height that compressibility of the inter-cell sealing material is 50% or more and 80% or less due to the rib.

The present disclosure can reduce a maximum amount of permanent deformation of the inter-cell sealing material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating the structure of a fuel cell stack 50;

FIG. 2 is an exploded perspective view of the fuel cell 10;

FIG. 3 is a plan view of the fuel cell 10;

FIG. 4 is a conceptual diagram illustrating a layer configuration of the power generation portion 11 of the fuel cell 10;

FIG. 5 is a conceptual diagram illustrating a layer configuration in the outer peripheral portion 21 of the fuel cell 10 (first form);

FIG. 6 is a conceptual diagram illustrating a layer configuration in the outer peripheral portion 21 of the fuel cell 10 (second form);

FIG. 7 is a diagram for explaining a portion of the stacked structure of the fuel cell 10 in the fuel cell stack 50 that is focused on the outer peripheral portion (first form);

FIG. 8 is a diagram illustrating a modification of the first form;

FIG. 9 is a view for explaining a portion of the fuel cell stack 50 in which attention is paid to the outer peripheral portion of the stack of fuel cells 10 (second form); and

FIG. 10 is a diagram illustrating a modification of the second form.

### DETAILED DESCRIPTION OF EMBODIMENTS

### 1. Basic Structure of Fuel Cell Stack

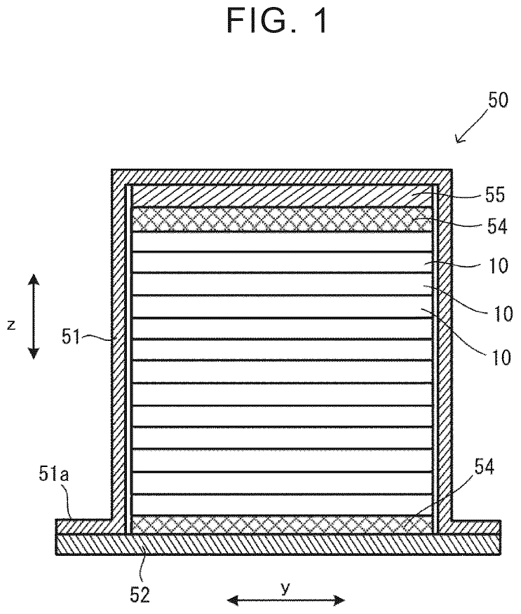

A fuel cell stack 50 is a member formed by stacking a plurality of (about 50 to 400) fuel cells 10 that will be described in detail later, and collects a current from the plurality of fuel cells 10. FIG. 1 shows an outline of the configuration. The fuel cell stack 50 includes a case 51, an end plate 52, a plurality of fuel cells 10, a current collector plate 54, and a biasing member 55.

In each figure, each direction of a three-dimensional orthogonal coordinate system is represented by an arrow. Here, in the in-plane direction of the fuel cell which is a flat plate as a whole, the x-direction is a direction from the inlet side to the outlet side of the fluid, and the y-direction is a direction orthogonal to the x-direction. The z-direction is a stacking direction of each member of the fuel cell having the stacked structure.

The case 51 is a housing that houses the plurality of fuel cells 10, the current collector plate 54, and the biasing member 55 that are stacked on top of each other. In the present embodiment, the case 51 has a rectangular cylindrical shape with one end open and the other end closed, and a piece in the form of a plate protrudes along the edge of the opening toward the opposite side from the opening to form a flange 51a.

The end plate 52 is a member in the form of a plate and closes the opening of the case 51. The end plate 52 is fixed to the case 51 such that the overlapping part of the case 51 with the flange 51a is covered with the case 51 by a bolt, a nut, or the like.

As will be described in detail later, the fuel cell 10 includes a plurality of stacked fuel cells 10. At this time, the anode separator 18 of an adjacent fuel cell 10 is disposed so as to overlap the cathode separator 15 of one fuel cell 10. Then, a groove 15b of the cathode separator 15 and a groove 18b of the anode separator 18 overlap to form a coolant channel.

The current collector plate 54 is a member that collects current from the stacked fuel cells 10. Therefore, the current collector plate 54 is disposed at one end and the other end in the stacking direction of the stack of the fuel cells 10, and one of them serves as a cathode and the other serves as an anode. A terminal, not shown, is connected to the current collector plate 54 so as to be electrically connected to the outside.

The biasing member 55 fits inside the case 51 and applies a pressing force to the stack of the fuel cells 10 in the stacking direction. The biasing member may be, for example, a Belleville spring.

### 2. Basic Structure of Fuel Cell

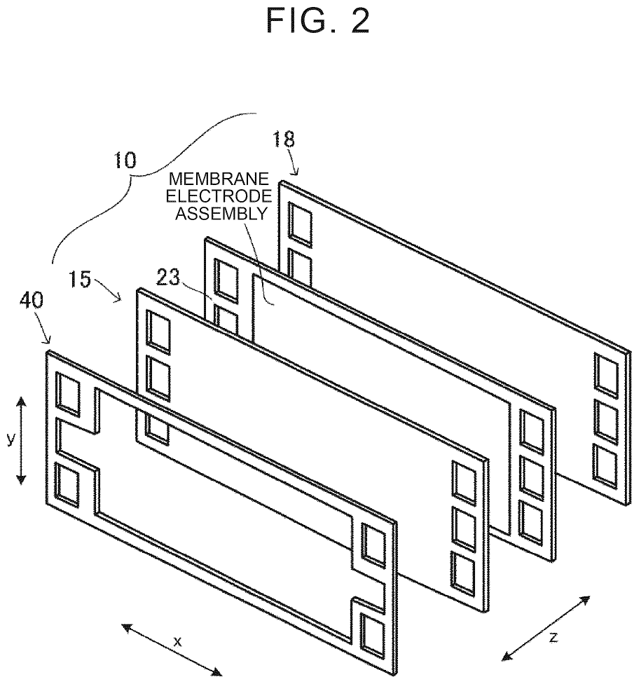

FIGS. 2 to 5 are diagrams illustrating the basic structure of the fuel cell 10 according to one embodiment. The fuel cell 10 is a unit element for generating electric power by supplying hydrogen and oxygen (air), and a plurality of such fuel cells 10 are stacked to form the fuel cell stack 50.

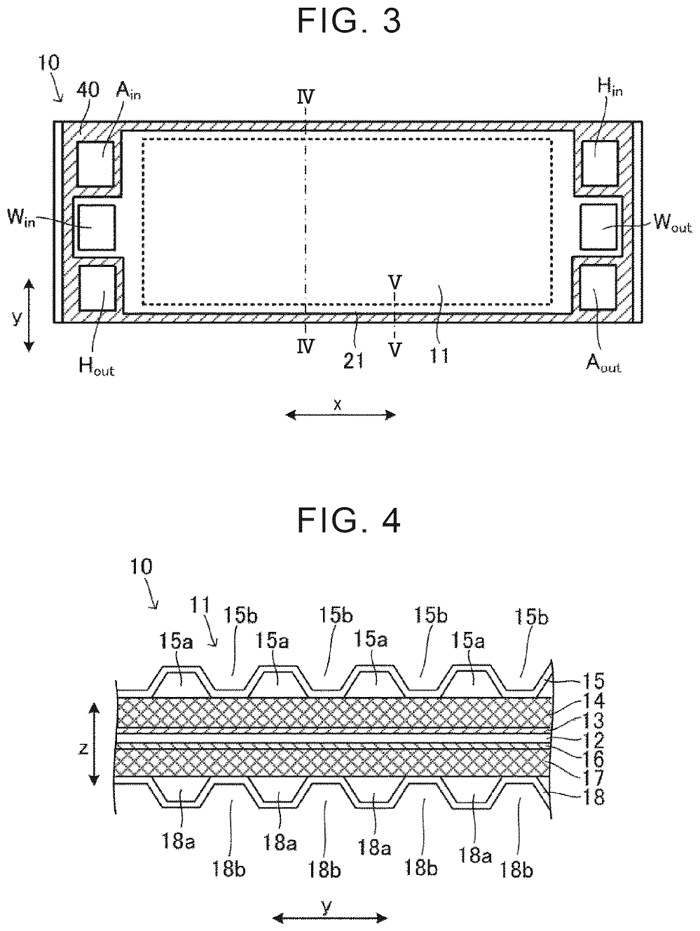

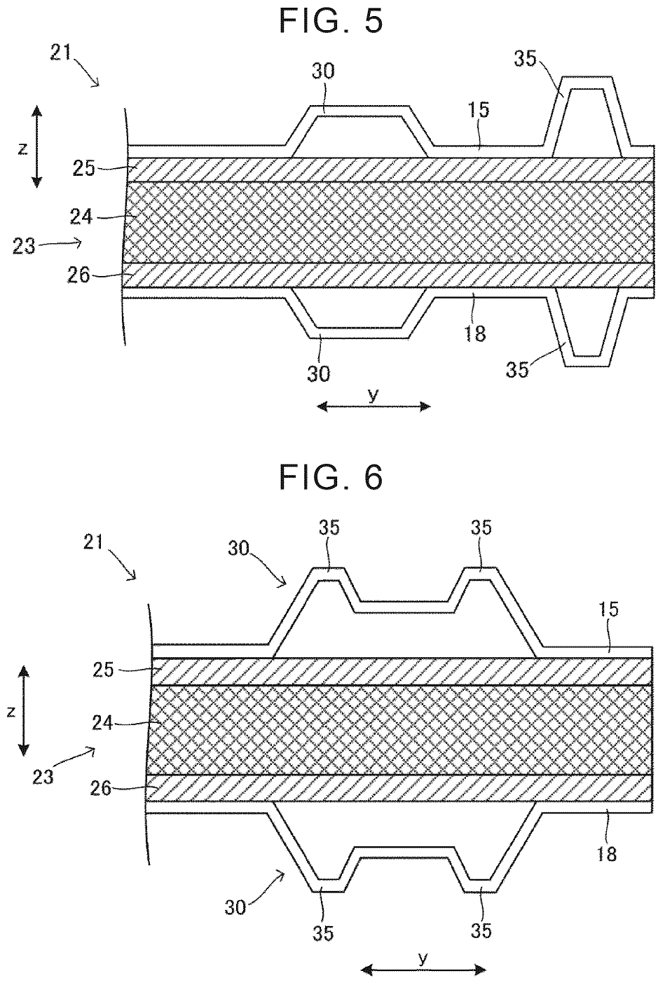

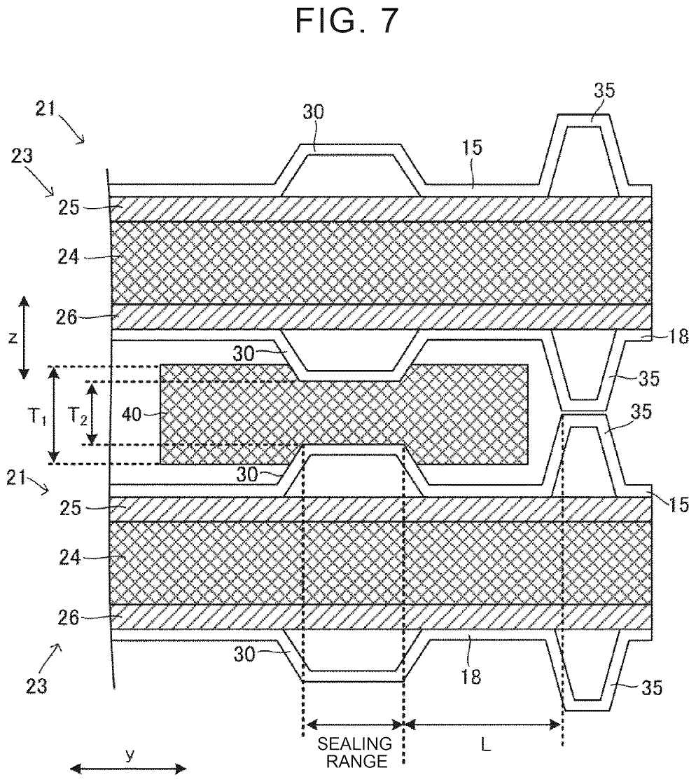

FIG. 2 is an exploded perspective view of the fuel cell 10 (FIG. 2 also shows an inter-cell sealing material 40 described later in addition to the fuel cell 10), and FIG. 3 is a plan view of the fuel cell 10 (FIG. 3 also shows an inter-cell sealing material 40 described later in addition to the fuel cell 10). FIG. 4 is a diagram for explaining a layer configuration of the fuel cell 10 in the power generation portion 11, and FIGS. 5 and 6 are diagrams for explaining a layer configuration of the fuel cell 10 in the outer peripheral portion 21.

### 2.1. Power Generation Portion

The power generation portion 11 is, for example, a portion that contributes to power generation in a portion surrounded by a dashed line in FIG. 3, and a plurality of layers are stacked in FIG. 4 as representing a layer configuration (a part of a IV-IV cross section) of the power generation portion 11.

In the power generation portion 11 of the fuel cell 10, a portion located one side with respect to the electrolyte membrane 12 is a cathode (oxygen supply side) and a portion located on the other side with respect thereto is an anode (hydrogen supply side). In the cathode, a cathode catalyst layer 13, a cathode diffusion layer 14, and a cathode separator 15 are stacked in this order from the electrolyte membrane 12 side. On the other hand, the anode includes an anode catalyst layer 16, an anode diffusion layer 17, and an anode separator 18 in this order from the electrolyte membrane 12 side. Note that a stack of the electrolyte membrane 12, the cathode catalyst layer 13, the cathode diffusion layer 14, the anode catalyst layer 16, and the anode diffusion layer 17 may be referred to as a membrane electrode assembly. The thickness of the membrane electrode assembly is typically about 0.4 mm, and the thickness of the fuel cell 10 in the power generation portion 11 is typically about 1.3 mm.

Each layer can be configured in a known manner, for example as follows.

### 2.1a. Electrolyte Membrane

The electrolyte membrane 12 is a solid polymer thin film exhibiting good proton conductivity in a wet state. For example, a fluorine-based ion exchange membrane can be used, and for example, a carbon-fluorine-based polymer can be used, and specific examples thereof include a perfluoroalkylsulfonic acid-based polymer (Nafion®).

The thickness of the electrolyte membrane 12 is not particularly limited, but is 100 μm or less, preferably 50 μm or less, and more preferably 10 μm or less.

### 2.1b. Cathode Catalyst Layer

The cathode catalyst layer 13 is a layer containing a catalyst metal in a form in which the catalyst metal is supported on a support. For example, the catalytic material may be Pt, Pd, Rh, or alloys containing them. Examples of the carrier include carbon particles composed of a carbon support, more specifically, glassy carbon, carbon black, activated carbon, coke, natural graphite, artificial graphite, and the like.

### 2.1c. Anode Catalyst Layer

Similarly to the cathode catalyst layer 13, the anode catalyst layer 16 is also a layer containing a catalyst metal in a form in which the catalyst metal is supported on a support. For example, the catalyst material may be Pt, Pd, Rh, or alloys containing them. Examples of the carrier include carbon particles composed of a carbon support, more specifically, glassy carbon, carbon black, activated carbon, coke, natural graphite, artificial graphite, and the like.

### 2.1d. Cathode Diffusion Layer

The cathode diffusion layer 14 may be formed of, for example, an electrically conductive porous material. Specific examples thereof include a porous carbon material (carbon paper, carbon cloth, glassy carbon, etc.) and a porous metal material (metal mesh, metal foam).

The cathode diffusion layer may be provided with a MPL (microporous layer) as needed. MPL is a coated thin film coated on the cathode catalyst layer 13 of the cathode diffusion layer 14. MPL has a function of adjusting water content by having water repellency and hydrophilicity as required. Typically, MPL is composed mainly of a water-repellent resin such as polytetrafluoroethylene (PTFE) and a conductive material such as carbon black.

### 2.1e. Anode Diffusion Layer

The anode diffusion layer 17 can be formed of, for example, an electrically conductive porous material. Specific examples thereof include a porous carbon material (carbon paper, carbon cloth, glassy carbon, etc.) and a porous metal material (metal mesh, metal foam).

### 2.1f. Cathode Separator

The cathode separator 15 is a member that supplies a reactive gas (air in the present embodiment) to the cathode diffusion layer 14, and has a plurality of grooves 15a on a surface facing the cathode diffusion layer 14, and these grooves function as reactive gas channels. The shape of the groove is not particularly limited as long as the reaction gas can be appropriately supplied to the cathode diffusion layer 14, and examples thereof include a mold in which a member in the form of a plate is formed in a corrugated shape as in the present embodiment. The plate thickness is typically 0.1 mm to 0.2 mm, and the height of the irregularities is typically 0.5 mm.

In the wavy shape, a groove 15b is formed between adjacent grooves 15a on the opposite side of the cathode separator 15, and this functions as a coolant channel.

As can be seen from FIG. 1, the cathode separator 15 is provided with an air inlet hole Aᵢₙ, a coolant inlet hole Wᵢₙ, and a hydrogen outlet hole Hₒᵤₜ at a position extending from the power generation portion 11 and extending outward at positions at one ends of the grooves 15a and the grooves 15b. In the portion located at the other ends of the grooves 15a and the grooves 15b, an air outlet hole Aₒᵤₜ, a coolant outlet hole Wₒᵤₜ, and a hydrogen inlet hole Hᵢₙ are provided. The grooves 15a communicate with the air inlet hole Aᵢₙ, the air outlet hole Aₒᵤₜ, and the grooves 15b communicate with the coolant inlet hole Wᵢₙ, and the coolant outlet hole Wₒᵤₜ.

The material constituting the cathode separator 15 may be any material that can be used as a separator of a fuel cell, and may be a gas impermeable conductive material. Examples of such a material include dense carbon obtained by compressing carbon to make it gas impermeable, and a pressed metal plate.

### 2.1g. Anode Separator

The anode separator 18 is a member for supplying a reaction gas (hydrogen) to the anode diffusion layer 17, and has a plurality of grooves 18a on a surface facing the anode diffusion layer 17, and these grooves function as a reaction gas channel. The shape of the groove is not particularly limited as long as the reaction gas can be appropriately supplied to the anode diffusion layer 17, and examples thereof include a mold in which a member in the form of a plate is formed in a corrugated shape as in the present embodiment. The plate thickness is typically 0.1 mm to 0.2 mm, and the height of the irregularities is typically 0.4 mm.

In the case of the corrugated shape, in this embodiment, a groove 18b is formed between adjacent grooves 18a on the other side of the anode separator 18, and this functions as a coolant channel.

Further, as can be seen from FIG. 1, the anode separator 18 is provided with an air inlet hole Aᵢₙ, a coolant inlet hole Wᵢₙ, and a hydrogen outlet hole Hₒᵤₜ at a position extending from the power generation portion 11 and extending outward at one ends of the grooves 18a and the grooves 18b. In the portion at the other ends of the grooves 18a and the grooves 18b, an air outlet hole Aₒᵤₜ, a coolant outlet hole Wₒᵤₜ, and a hydrogen inlet hole Hᵢₙ are provided. Here, the grooves 18a communicate with the hydrogen inlet hole Hᵢₙ, the hydrogen outlet hole Hₒᵤₜ, and the grooves 18b communicate with the coolant inlet hole Wᵢₙ, and the coolant outlet hole Wₒᵤₜ.

The material constituting the anode separator 18 may be any material that can be used as a separator for a fuel cell, and may be a gas impermeable conductive material. Examples of such a material include dense carbon obtained by compressing carbon to make it gas impermeable, and a pressed metal plate.

### 2.1h. Power Generation by Power Generation Portion

As is known in the art, the fuel cell 10 described above generates electric power as follows.

When hydrogen is supplied from the grooves 18a of the anode separator 18, the hydrogen passes through the anode diffusion layer 17. Thereafter, hydrogen is decomposed into protons (H⁺) and electrons (e⁻) in the anode catalyst layer 16. The protons pass through the electrolyte membrane 12, and the electrons pass through a conductive line connected to the outside. The protons and electrons then reach the cathode catalyst layer 13. Oxygen (air) is supplied to the cathode catalyst layer 13 from the grooves 15a of the cathode separator 15 via the cathode diffusion layer 14, and in the cathode catalyst layer 13, water (H₂O) is generated by protons, electrons, and oxygen. The generated water passes through the cathode diffusion layer 14, reaches the grooves 15a of the cathode separator 15, and is discharged.

That is, in the fuel cell 10, the flow of electrons through the conductive line connected to the outside from the anode catalyst layer 16 is used as a current.

### 2.2. Outer Peripheral Portion

The outer peripheral portion 21 is an outer peripheral portion of the fuel cell 10 outside the power generation portion 11 surrounded by a dashed line in FIG. 3, and is a portion that does not contribute to power generation but supplies various fluids to the power generation portion, collects fluids from the power generation portion, and seals them. The outer peripheral portion 21 is formed by laminating a plurality of layers as shown in FIGS. 5 and 6 for showing a layer configuration (V-V cross section) of the outer peripheral portion 21. Specifically, in the present embodiment, the outer peripheral portion 21 has the following configuration. FIG. 5 is a first form, and FIG. 6 is a second form.

In the outer peripheral portion 21, a resin sheet 23 is disposed between the cathode separator 15 and the anode separator 18, and the inside of the fuel cell 10 is sealed by the resin sheet 23. As can be seen from FIG. 2, the resin sheet 23 is arranged so as to surround the membrane electrode assembly.

The resin sheet 23 functions as a sealing member that seals and seals between the cathode separator 15 and the anode separator 18 in the outer peripheral portion 21 of the fuel cell 10. The resin sheet 23 includes a base material 24, an adhesive layer 25 disposed on one side of the base material 24 (the surface on the cathode separator side), and an adhesive layer 26 disposed on the other side of the base material 24 (the surface on the anode separator side). The adhesive layer 25 is adhered to the cathode separator 15, and the adhesive layer 26 is adhered to the anode separator 18, thereby sealing and sealing the inside of the power generation portion 11.

The base material 24 is formed of a thermoplastic resin material having electrical insulation and airtightness and having a relatively high melting point. Examples of such materials include polyethylene naphthalate, polyphenylene ether, and polyphenylene sulfide. The thickness of the base material 24 is not particularly limited, but is preferably not less than 0.05 mm and not more than 0.25 mm.

The adhesive layer 25 and the adhesive layer 26 are composed of an adhesive and a pressure-sensitive adhesive.

In the outer peripheral portion 21, a protruding portion 30 that is a protrusion protruding in the z-direction and a rib 35 are provided in each of the anode separator 15 and the anode separator 18.

As will be described later, the protruding portion 30 is a portion that forms a sealing range by the inter-cell sealing material 40 disposed between adjacent fuel cells 10 in a state in which the fuel cells 10 are stacked in the fuel cell stack 50. The rib 35 is a portion that serves as a stopper for limiting the degree to which the inter-cell sealing material 40 is compressed.

Specific shapes of the protruding portion 30 and the ribs 35 will be described later.

### 3. Seal Between Cells in Outer Peripheral Portion

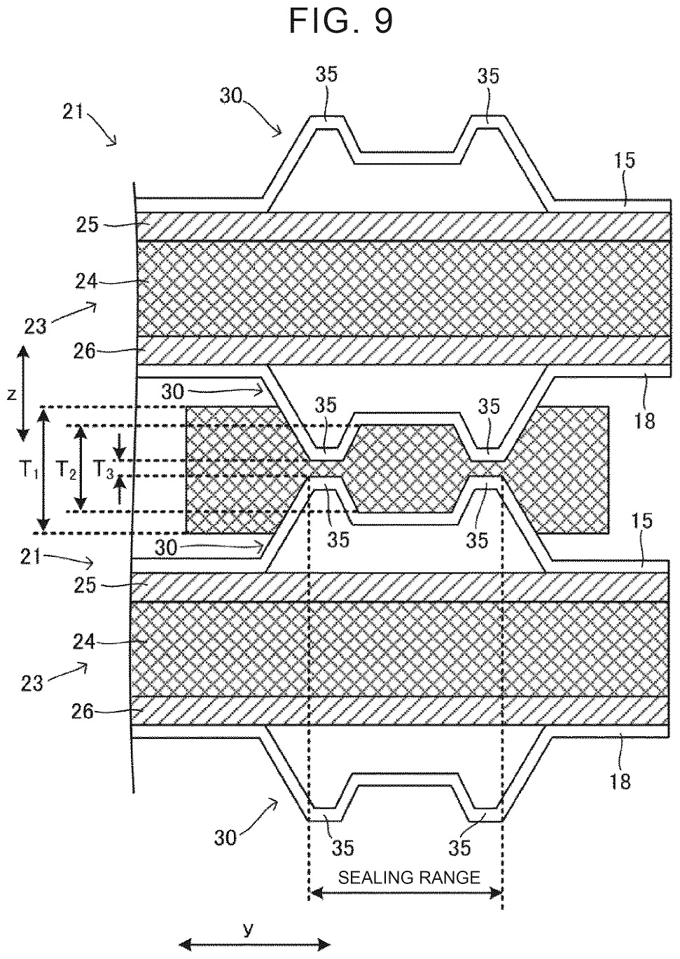

FIGS. 7 and 9 show the stacked structure of the fuel cell stack 50, which focuses on the outer peripheral portion 21 of the fuel cell 10. FIG. 7 shows a first form and shows a stacking mode of two adjacent fuel cells 10 from the same viewpoint as FIG. 5, and FIG. 9 shows a second form and shows a stacking mode of two adjacent fuel cells 10 from the same viewpoint as FIG. 6.

In both forms, the inter-cell sealing material 40 is disposed between adjacent fuel cells 10 in the outer peripheral portion 21. Therefore, the inter-cell sealing material 40 contacts the top of the protruding portion 30, and the protruding portion 30 is laminated so as to press the inter-cell sealing material 40. Therefore, in the present embodiment, the inter-cell sealing material 40 is a frame-shaped sheet member arranged along the outer peripheral portion 21 as shown in FIGS. 2 and 3 (shown by hatched in FIG. 3).

The inter-cell sealing material 40 may be formed of a pressure-sensitive adhesive sheet. The pressure-sensitive adhesive sheet may be a thermoplastic resin such as a polyester-based resin or a modified olefin-based resin, or may be a thermosetting resin that is a modified epoxy resin. The thickness of the pressure-sensitive adhesive sheet is not particularly limited, and may be 10 μm or more and 100 μm or less.

The pressure-sensitive adhesive sheet may have a two-layer structure including a first pressure-sensitive adhesive layer and a second pressure-sensitive adhesive layer in this order, or may have a three-layer structure including a first pressure-sensitive adhesive layer, a rubber layer, and a second pressure-sensitive adhesive layer in this order. The first pressure-sensitive adhesive layer and the second pressure-sensitive adhesive layer may be made of the same material or different materials. The thickness of the pressure-sensitive adhesive layer is not particularly limited, and may be 5 μm or more and 50 μm or less. The first pressure-sensitive adhesive layer and the second pressure-sensitive adhesive layer may have the same thickness or different thicknesses.

Examples of the rubber layers include EPDM (ethylene propylene diene rubber), fluorine-based rubber, and silicone-based rubber. The thickness of the rubber layer is not particularly limited, and may be 5 μm or more and 90 μm or less.

Therefore, the first pressure-sensitive adhesive layer is stuck to the protruding portion 30 on one side of the fuel cell 10 adjacent to the second pressure-sensitive adhesive layer in contact with the protruding portion 30 on the other side, thereby forming a seal.

### 3.1. First Form

As shown in FIGS. 5 and 7, in the first form, the protruding portion 30 has a trapezoidal cross section and extends in the back/front direction of the drawing while maintaining the cross section. A short upper bottom side, which is a trapezoidal cross section, becomes a protruding side and contacts the inter-cell sealing material 40. Therefore, in this form, the sealing range is the range of the size of the upper bottom as shown in FIG. 7 by the inter-cell sealing material 40.

Further, the rib 35 is a protrusion disposed outside the protruding portion 30 (on the outer peripheral side of the fuel cell 10). As can be seen from FIG. 7, the ribs 35 are arranged so that the ribs 35 face each other in the fuel cell 10 adjacent to each other. According to this configuration, when a force is applied in a direction in which the interval between adjacent fuel cells 10 is reduced due to an external force etc. (that is, when the inter-cell sealing material 40 is going to be compressed), the opposing ribs 35 come into contact with each other and function as a stopper that restricts further movement.

Therefore, the protruding height (size in the z-direction) of the rib 35 is set to be larger than at least the protruding height of the protruding portion 30, and is set to be such a size that limits the compressibility of the inter-cell sealing material 40 so that it does not become larger than the compressibility range described below.

The protruding height of the protruding portion 30 is adjusted such that the compressibility, namely T₂/T₁ expressed as a percentage, is 20% or more and 70% or less, where T₁ represents the thickness of the opening portion of the inter-cell sealing material 40 (size in the z-direction of the portion not subjected to a load), and T₂ represents the thickness of the inter-cell sealing material 40 in the sealing range. Therefore, the protruding height of the rib 35 is set to such a magnitude that can regulate the compressibility such that the compressibility does not become higher than 70%.

Further, the distance between the sealing range and the rib 35 (the distance between the side of the sealing range closest to the rib 35 and the protruding portion 30 side of the highest portion of the rib 35) shown by L in FIG. 7 is not particularly limited, but is preferably not less than 2 mm and not more than 10 mm.

According to such a form, the adjacent fuel cells 10 cannot approach the distance that the ribs 35 are in contact with each other or more, and the inter-cell sealing material 40 is not compressed any more. Therefore, it is possible to reduce a maximum amount of permanent deformation of the inter-cell sealing material 40 because it is not subjected to an unintended, more than necessary compressive force.

Further, the rib 35 can suppress the gas pressure in the fuel cell 10 and the deformation of the separator due to the expansion of the member.

Here, although the upper bottom side of the protruding portion 30 is flat, the present disclosure is not limited thereto, and the upper bottom side may be arcuate or a protrusion may be provided.

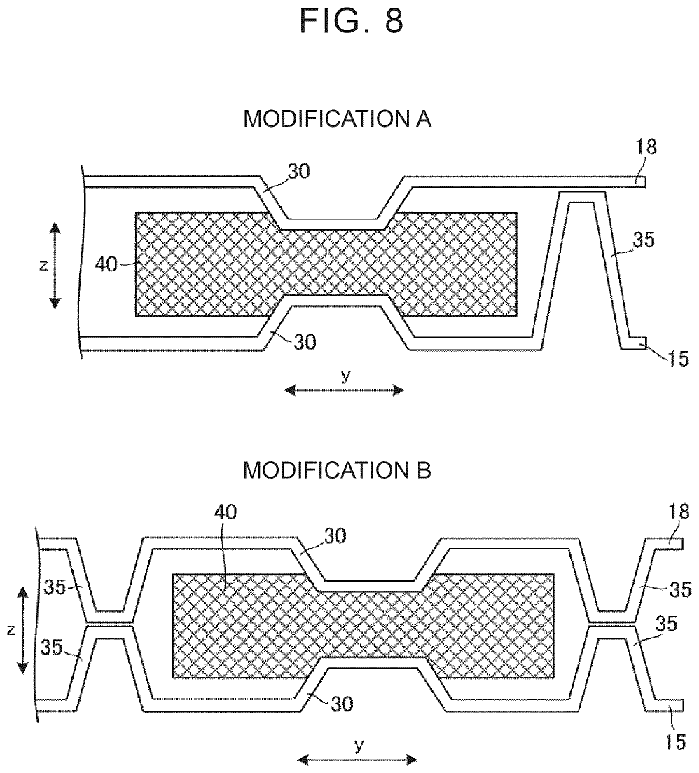

FIG. 8 shows a modification of the first form. In FIG. 8, only the inter-cell sealing material 40 and the two separators 15, 18 in contact therewith are shown in a simple manner. In Modification A of FIG. 8, the rib 35 is disposed on one of the two separators 15, 18 (only the separator 18 in the example of the drawing). In addition to this form, the rib 35 of the separator 15 and the rib 35 of the separator 18 may have different heights (size in the z-direction) and widths (size in the y-direction).

A modification B of FIG. 8 is an example in which the ribs 35 are disposed on both sides of the inter-cell sealing material 40.

### 3.2. Second Form

As shown in FIGS. 6 and 9, in the second form, the protruding portion 30 has a trapezoidal cross section, and two ribs 35 provided at both ends of the upper bottom protrude from the upper bottom, and extend in the back/front direction of the drawing while maintaining the cross section. A short upper bottom side, which is a trapezoidal cross section, serves as a protruding side, and the upper bottom and the rib 35 come into contact with the inter-cell sealing material 40 to press the inter-cell sealing material 40. Therefore, in this form, the sealing range of the inter-cell sealing material 40 is the range of the size of the upper base including the ribs 35, as shown in FIG. 9.

The protruding portion 30 defines a sealing range, and the ribs 35 function as a stopper that restricts compression of the inter-cell sealing material 40 in the protruding portion 30 other than the ribs 35, in the same manner as in the first form. However, in this form, since the inter-cell sealing material 40 is present between the two ribs 35 facing each other in the z-direction, it is not restricted by direct contact between the ribs 35. Specifically, we consider the following.

The protruding height of the protruding portion 30 is adjusted such that the compressibility, namely T₂/T₁ expressed as a percentage, is 20% or more and 70% or less, where T₁ represents the thickness of the opening portion of the inter-cell sealing material 40 (size in the z-direction of the portion not subjected to a load), and T₂ represents the thickness of the inter-cell sealing material 40 in the sealing range other than the ribs 35. The ribs 35 have such a protruding height that can regulate the compressibility, namely T₂/T₁ expressed as a percentage, such that the compressibility does not become higher than 70% in the range in which compressibility, namely T₃/T₁ expressed as a percentage, is 50% or more and 80% or less, where T₃ represents the thickness of the portion of the inter-cell sealing material 40 between the ribs 35.

According to such a form, the inter-cell sealing material 40 is greatly compressed between the opposing ribs 35, and the distance between the protruding portions is not reduced in the other portion of the protruding portion 30, and the inter-cell sealing material 40 is not further compressed. Therefore, it is possible to reduce a maximum amount of permanent deformation of the inter-cell sealing material 40 because it is not subjected to an unintended, more than necessary compressive force. The inter-cell sealing material 40 is greatly compressed between the ribs 35. Even if the inter-cell sealing material 40 is permanently deformed in this portion, permanent deformation of the remaining portion is reduced by the protruding portion 30. Therefore, the sealing property is maintained.

Here, although the upper bottom side of the protruding portion 30 is flat, the present disclosure is not limited thereto, and the upper bottom side may be arcuate or a protrusion may be provided.

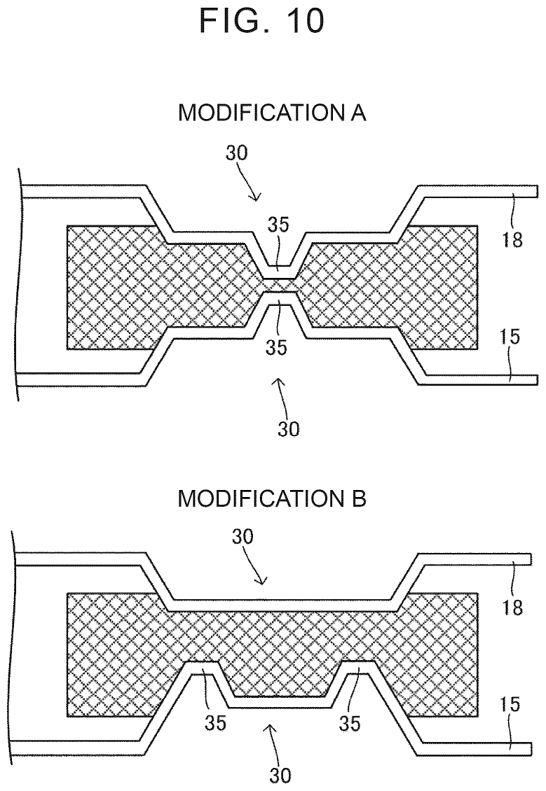

FIG. 10 lists a modification of the second form. In FIG. 10, only the inter-cell sealing material 40 and the two separators 15, 18 in contact therewith are shown in a simple manner.

Modification A of FIG. 10 is an example in which one rib 35 is disposed on one protruding portion 30. The position of one rib 35 is not particularly limited, and may be at the center of protruding portion 30 in the y-direction as in Modification A of FIG. 10, or may be at the end of the protruding portion 30, although not shown, or may be any other position.

In Modification B of FIG. 10, the rib 35 is disposed on one of the two separators 15, 18 (only the separator 15 in the example of the drawing). In addition to this form, the rib 35 of the separator 15 and the rib 35 of the separator 18 may have different heights (size in the z-direction) and widths (size in the y-direction). The separator on one side of the inter-cell sealing material 40 and the separator on the other side thereof may be formed to be different in form. For example, the rib 35 of FIG. 9 may be applied to one separator, and the rib 35 of Modification A of FIG. 10 may be applied to the other separator.

What is claimed is:

1. A fuel cell stack comprising:
a plurality of fuel cells; and
an inter-cell sealing material disposed between the fuel cells, wherein:
the fuel cells include a rib located outside a sealing range of the inter-cell sealing material, the rib protruding in a direction of adjacent ones of the fuel cells; and
the rib has such a height that compressibility of the inter-cell sealing material is 20% or more and 70% or less in the sealing range.

2. The fuel cell stack according to claim 1, wherein the rib is provided in a separator of the fuel cell.

3. The fuel cell stack according to claim 2, wherein the sealing range is defined by a protruding portion provided in the separator.

4. A fuel cell stack comprising:
a plurality of fuel cells; and
an inter-cell sealing material disposed between the fuel cells,
wherein the fuel cells include two or more ribs located inside a sealing range of the inter-cell sealing material.

5. The fuel cell stack according to claim 4, wherein the rib has such a height that compressibility of the inter-cell sealing material is 20% or more and 70% or less in the sealing range other than the rib.

6. The fuel cell stack according to claim 4, wherein the rib has such a height that compressibility of the inter-cell sealing material is 50% or more and 80% or less due to the rib.
